(19) United States
(12) Patent Application Publication
(10) Pub. No.: US 2024/0126009 A1
(43) Pub. Date: Apr. 18, 2024

(54) SYSTEMS AND METHODS FOR ENHANCED BACK SCATTERING IN OPTICAL FIBERS WITH HERMETICITY

(71) Applicant: OFS FITEL, LLC, Norcross, GA (US)

(72) Inventors: Raja A Ahmad, South Bound Brook, NJ (US); Paul S Westbrook, Basking Ridge, NJ (US)

(73) Assignee: OFS FITEL, LLC, Norcross, GA (US)

(21) Appl. No.: 18/276,915

(22) PCT Filed: Feb. 14, 2022
(86) PCT No.: PCT/US22/16359

§ 371 Date: Aug. 11, 2023

Related U.S. Application Data
(60) Provisional application No. 63/148,927, filed on Feb. 12, 2021.

(51) Int. Cl. G02B 6/02

(52) U.S. Cl. CPC G02B 6/02147

(57) ABSTRACT

Described herein are systems, methods, and articles of manufacture for high back-scattering waveguides (e.g., optical fibers) and sensors employing high back-scattering optical fibers. Briefly described, one embodiment comprises a high back-scattering fiber, or enhanced scattering fiber or “ESF,” that features resistance specifications that remain intact over lengths of fiber in excess of 1 m, or preferably >100 m, or preferably >1 km, wherein the reflectivity of the ESFs may be precisely tuned within a range from −100 dB/mm to −70 dB/mm, and wherein the enhanced scattering may be spatially continuous or, alternatively, may be at discrete locations spaced apart by 100 microns to >10 m.

### CROSS-REFERENCE TO RELATED APPLICATIONS

This application claims the benefit of U.S. Provisional Application No. 63/148,927, filed Feb. 12, 2021, and herein incorporated by reference.

### TECHNICAL FIELD

Described herein are systems, methods, and articles of manufacture for enhanced back-scattering in optical fibers with hermeticity.

### BACKGROUND OF THE INVENTION

Back-scattered light in an optical fiber is used for distributed acoustic sensing. This has significant application in, for instance, so-called downhole applications in oil and gas exploration, but the high temperature and high hydrogen environment in such wells cause rapid degradation of conventional optical fiber. The addition of a hermetic carbon coating and the use of germanium-free (“Ge-free”) cores has improved fiber lifetime in such harsh environments.

To increase the sensitivity to acoustic events, refractive index perturbations may be introduced along the optical fiber to increase the amount of back-scattered light. While this is well known for conventional fiber, introducing index perturbations in carbon-coated and Ge-free fiber is problematic for many reasons. In particular, actinic radiation at, for instance, UV wavelengths is not effective in Ge-free fibers, requiring the use of femtosecond pulse writing. Furthermore, actinic pulse (e.g., femtosecond laser pulse) writing damages the silica glass structure, causing an increase in optical loss. While this could be acceptable for short gratings for specific applications, distributed sensing over hundreds of meters produces an unacceptable loss. Finally, actinic exposure is known to damage the carbon coating, degrading hermeticity and reducing mechanical reliability.

Thus, there remains a problem in the art of producing long lengths of actinic pulse-inscribed gratings in Ge-free fiber with a hermetic coating.

### SUMMARY OF THE INVENTION

The present disclosure provides high back-scattering waveguides (e.g., optical fibers) and sensors employing high back-scattering optical fibers. Briefly described, one embodiment comprises a high back-scattering fiber, or enhanced scattering fiber or “ESF,” that features resistance specifications that remain intact over lengths of fiber in excess of 1 m, or preferably >100 m, or preferably >1 km, wherein the reflectivity of the ESFs may be precisely tuned within a range from −100 dB/mm to −70 dB/mm, and wherein the enhanced scattering may be spatially continuous or, alternatively, may be at discrete locations spaced apart by 100 microns to >10 m.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Referring now to the drawings:

FIG. 1A shows a schematic diagram of the FBG writing setup in accordance with one embodiment of the present invention;

FIG. 1B shows a projection of beam focused at the center of the core during the FBG writing process in accordance with one embodiment of the present invention;

FIG. 1C shows a cross-sectional view of the hermetically coated optical fiber in accordance with one embodiment of the present invention; and

FIG. 1D shows a depiction of the inscribed FBGs along the length of the hermetically coated fiber in accordance with one embodiment of the present invention.

### DETAILED DESCRIPTION

The exemplary embodiments described herein relate to enhanced back-scattering in optical fibers with hermeticity. More specifically, exemplary embodiments relate to actinic pulse written gratings in an optical fiber that has a hermetic (carbon) coating in which the relative intensities at the coating and core are adjusted so that the writing process does not degrade the aging characteristics of optical or mechanical properties when the fiber is exposed to “harsh” environment. The resulting fiber device, which can vary from a few millimeters to kilometers in length, exhibits overall transmission loss <2 dB/km and a back-scattering larger than native Rayleigh scattering (Enhanced scattering fiber or “ESF”) and a scattering figure of merit (FOM) >1 (U.S. Pat. No. 9,766,396) over at least one range of optical frequencies, caused by the spatial modulation of refractive-index (Δn) in at least part of the core of the fiber waveguide to enable stable and non-destructive operation, without a significant increase in optical attenuation, for >50 hours at high temperatures (>30° C.) and under other harsh environmental conditions (humidity levels >50% and or hydrogen exposure with partial pressure >0.1 psi and/or strain >0.5%).

Refractive-index modification of the selective region(s) in an optical material enables it with advanced functionalities via control over the behavior of the launched light—the result is a useful photonic structure. A back-scattering fiber is one such photonic structure that relies on the spatial-variation of the refractive index of the material and enables a change in the path of some portion of the propagating light—typically in the reverse direction with respect to the original direction of lightwave propagation—by satisfying the phase-matching conditions between the wave-vector of the light wave and the vector corresponding to the spatial frequency of the physical variation in the refractive index of the medium.

A number of conventional and future applications of ESF necessitate the ability to offer stable and robust long-term operation under harsh environmental conditions, such as high temperature, high humidity, and underexposure to highly corrosive chemicals or gases. Such harsh environments are known to increase the transmission loss of the fiber and to compromise the performance of the ESF, thereby sacrificing the long-term reliability and operation of the photonic device and the overall system. The germanium co-doping of the fiber core, for lending photosensitivity to the silica glass for ESF inscription using UV-radiation, is known to substantially increase the transmission losses under hydrogen-rich environments. This renders such photonic systems prone to failure and, therefore, impractical for a reliable and long-term operation. In order to circumvent these challenges, the coating materials have been engineered for fiber protection and for sustaining the long-term operation of the fiber and the enhanced scatter. The coatings technologies relying on carbon and polymer materials, such as polyimide, have been applied for the ESFs aimed at operation under harsh conditions by avoiding increased losses and degradation of the mechanical strength.

Furthermore, in order to avoid the use of germanium co-doping of the fiber core, “pure-core” (germanium undoped) fibers have been developed for higher resistance to degradation in hydrogen-rich environments. The use of pure-core fibers and the application of coatings that can add increased protection against harsh environments require the use of alternative methods for ESF fabrication. One approach is the use of lasers emitting short pulses on the scale of femtosecond to picosecond in duration. Such laser pulses may be operated at a wavelength that passes through the coatings with reduced loss in radiation intensity and is directly focused in the core region of the fiber to inscribe ESFs of desired periods and configurations. The index-modulation induced by such lasers relies on the nonlinear absorption by the glass matrix and is not dependent on the presence of germanium content, thus enabling the inscription of ESFs in the pure-core fibers. The ESFs can be inscribed on the fiber “off-tower” after the fiber has been coated with the carbon and polymer layers. This allows mechanical strength of the fiber after the inscription of the ESFs. The amount of index-change and length of the ESFs is chosen based on the desired reflectivity and its spatial distribution and can be tailored for a target application. The resulting ESF-inscribed fibers can be used as sensors and reflectors for use in transportation, energy exploration, nuclear reactors, telecommunication, and traffic monitoring networks and for monitoring critical infrastructure.

The exemplary embodiments described herein relate to systems and methods for ESF fabrication in optical fibers with hermetic coatings such as carbon and/or polyimide polymer coatings, as well as in undoped-core optical fibers. Critically, the fiber has a certain resistance to hydrogen diffusion and humidity and other chemical resistance, a certain thermal resistance, a certain strain resistance, and after the processing step that produces the enhanced scattering, the hydrogen, humidity, and other chemical resistance remains intact. In particular, these harsh resistance specifications remain intact over lengths of fiber in excess of 1 m, or preferably >100 m, or preferably >1 km. The reflectivity of the ESFs can be precisely tuned from −100 dB/mm to −70 dB/mm. The enhanced scattering can be spatially continuous or can be at discrete locations spaced apart by 100 microns to >10 m.

Examples of ESFs include 1) continuous periodic or quasi-periodic index perturbations. 2) Isolated index perturbations located along the fiber with spacings anywhere from 100 μm to 10 m. The isolated scattering centers may have a spatial extent of anywhere from 1 micron to >10 cm. The isolated scattering centers may have a spectral reflection bandwidth of preferably <10 nm or preferably <30 nm or preferably <100 nm. The scattering may be centered between 1500 and 1700 nm. The scattering may also be very broadband. It may be present at all wavelengths at which Rayleigh scattering occurs.

Such an ESF will have the same hermeticity both before and after treatment to produce the perturbations. Alternatively, the hermeticity will remain above a certain level, which is still a factor of 2 or preferably ten times greater than that of the fiber without the hermetic sealing. For instance, the attenuation arising from the reduced hermiticity will be only 2 to 10 times greater than in the untreated fiber, for the same partial pressure of hydrogen or water vapor, temperature, and time of exposure.

For example, a fiber with a Ge-free core and coated with carbon and then polyimide may be fabricated. This fiber may then be exposed to actinic radiation that penetrates through the polyimide and carbon coatings and changes the index of the core of the fiber resulting in back-scattering greater than Rayleigh scattering. The change in refractive index may form a series of planes that cross the fiber core and result in a periodic or quasi-periodic structure in the fiber core. The length of this structure may be anywhere from 1 micron to 10 cm or greater in length. The spacing of individual structures may be anywhere from 100 microns to 10 m. Importantly, the actinic radiation enters the fiber, and any excess actinic radiation leaves the fiber without altering any of the harsh resistance specifications. Therefore, the hermeticity, thermal stability, and strain resistance remain the same after the index change has been placed in the fiber. For example, this can be achieved if the actinic radiation has sufficiently low intensity when it passes through the carbon and the polyimide coatings such that it does not damage these coatings. Or alternatively, the damage may be sufficiently small that the resistant properties of the fiber are only partially degraded.

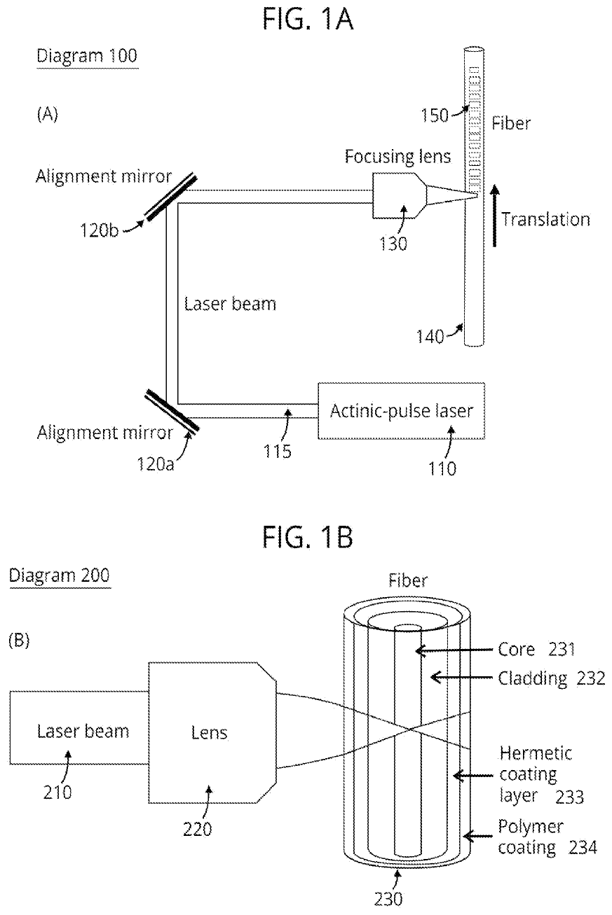

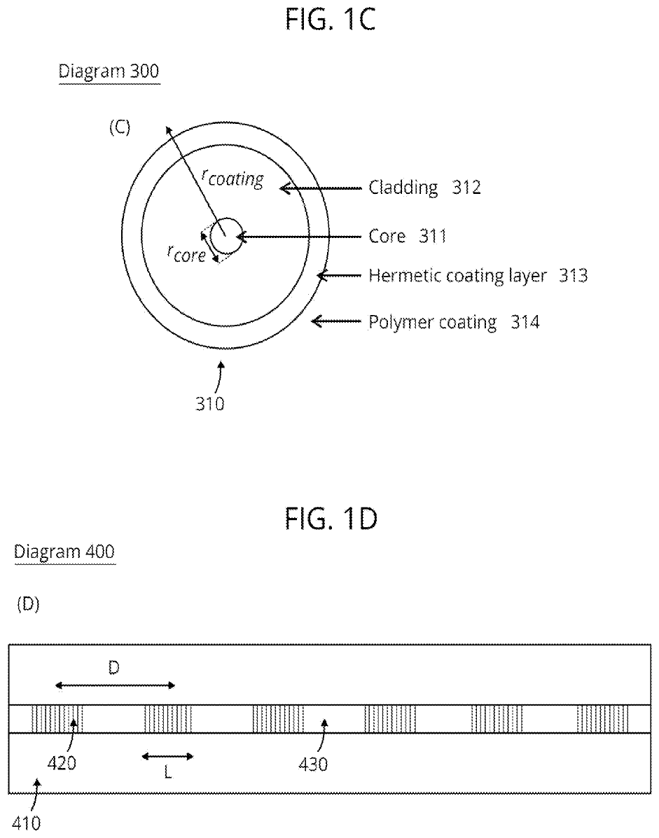

For example, the beam of actinic radiation may be focused in such a way that the peak intensity is below the damage threshold for the polymer and carbon coatings. A detailed schematic diagram of the experimental setup is included in FIG. 1A. Moreover, the focusing of the actinic beam may be adjusted so that as the beam leaves the fiber, it is also below the damage threshold of the coatings on the fiber. One way to accomplish this focusing is to adjust the focal point of the actinic beam to overlap with the fiber core. If the waist size of the beam is sufficiently small, then the actinic beam will expand away from the core region to an extent that it has greatly reduced intensity when it passes through the fiber coatings.

FIG. 1A shows a schematic diagram 100 of the FBG writing setup in accordance with one or more embodiments of the present invention. Specifically, diagram 100 illustrates an actinic-pulse laser 110 that emits a laser beam 115. The laser beam 115 is redirected using a plurality of alignment mirrors 120a, 120b. The laser beam 115 then traverses through a focusing lens 130. The focusing lens 130 focuses the laser beam 115 on an optical fiber 140 and inscribes an enhanced back-scattering grating 150.

FIG. 1B shows a diagram 200 of a projection of laser beam 210 focused via a lens 220 at the center of a core 231 of an optical fiber 230 during the FBG writing process in accordance with one or more embodiments of the present invention. According to an exemplary embodiment, the optical fiber 230 may feature a core 231, a cladding 232, a hermetic coating layer 233, and a polymer coating 234.

FIG. 1C shows a diagram 300 of a cross-sectional view of the hermetically coated optical fiber 310 in accordance with one or more embodiments of the present invention. Similar to the optical fiber 230 of FIG. 1B, the exemplary hermetically coated optical fiber 310 may feature a core 311 having a radius of r_{core}, a cladding 312, a hermetic coating layer 313, and a polymer coating 314 having a radius of r_{coating}.

FIG. 1D shows a diagram 400 of the inscribed FBGs 420 along the length of a core 430 of a hermetically coated fiber 410 in accordance with one or more embodiments of the present invention.

In general, the effect of the actinic beam is controlled by several factors: wavelength, pulse duration, rep rate, peak intensity in the fiber core, and peak intensity at the entrance and exit facet of the fiber. According to this invention, these parameters may be adjusted so that the effect on the core is sufficient to give the desired index modulation, and the effect on the coatings is such that they are not damaged by the radiation.

To quantify these ideas, the thresholds for the glass core and the fiber coatings may be considered as follows: I_{glass index change}=intensity required to change the index of the fiber core by an amount sufficient to increase the scattering FOM (from U.S. application Ser. No. 15/175,656, filed on Jun. 7, 2016, and issued as U.S. Pat. No. 9,766,396, is incorporated herein by reference) by the desired amount I_{coating damage}=intensity that will damage the hermetic coating or compromise the mechanical strength of the fiber.

In general, then, the actinic beam parameters may be adjusted so that

I_{beam}(r_{core})>I_{glass index change}
and

I_{beam}(r_{coating})<I_{coating damage}
where, I_{beam}(r_{core}) and I_{beam}(r_{coating}) denote the beam intensities at the outer edge of the fiber core (r_{core}) and coating (r_{coating}), respectively.

For example, it may be considered what these values are for a standard germanosilicate fiber coated with a thin layer of carbon. The index modifications are introduced using a femtosecond laser operating near 800 nm and with a pulse duration on the order of 150 fs. The threshold value for changing the core of this fiber is:

I_{glass index change}=1.8±0.4×10¹³ W/cm²

It may be estimated that the threshold for damaging the carbon coating would be

I_{coating damage}=1×10¹² W/cm²

Therefore, from the above formulas,

I_{beam}(r_{coating})<1×10¹² W/cm²

I_{beam}(r_{core})>1.8±0.4×10¹³ W/cm²

The formulas imply that the beam may be defocused at the surface of the fiber. If it is assume that the beam is focused at the center of the fiber, the radial dependence of the beam may be approximated using Gaussian beam formula:

$$ω ( r ) = {ω}_{0} \sqrt{1 + {( \frac{r λ}{π {ω}_{0}^{2} n} )}^{2}}$$

where, λ is the pulse wavelength, ω₀ is the beam waist, n is the refractive index of glass r is the distance from the core, and ω(r) is the beam waster at r. Using this relation, the ratio of the beam dimensions may be estimated at the core and coating radii. For simplicity, the cylindrical focusing may be excluded from the curved surface of the fiber. This effect can be included in the computation, or it may be eliminated or reduced by immersion of the fiber in the material of the desired refractive index, such as index-matching oil, which would eliminate lensing effects at the fiber surface. For a standard fiber with a very thin (<1 micron) carbon coating layer, the radius of the glass fiber cladding may be used, which is 62.5 μm for a standard fiber. The ratio of intensities after cylindrical focusing on the axis orthogonal to the fiber axis would be estimated to be:

$$\frac{{I}_{beam} ( {r}_{core} = 0 )}{{I}_{beam} ( {r}_{coating} )} = \frac{{ω}_{0} \sqrt{1 + {( \frac{{r}_{coating} λ}{π {ω}_{0}^{2} n} )}^{2}}}{{ω}_{0}} = \sqrt{1 + {( \frac{{r}_{coating} λ}{π {ω}_{0}^{2} n} )}^{2}}$$

Therefore, the beam parameters should satisfy

$$\sqrt{1 + {( \frac{{r}_{coating} λ}{π {ω}_{0}^{2} n} )}^{2}} > \frac{{I}_{glass index change}}{{I}_{coating damage}}$$

One can estimate the required beam waste ω₀ assuming λ=800 nm, n=1.5,

$$\frac{{I}_{glass index change}}{{I}_{coating damage}} = \frac{1.8 \times {10}^{13} W / {cm}^{2}}{1 \times {10}^{12} W / {cm}^{2}} = 18 ,$$

and r_{coating}=62.5 μm. In this case, the following equation may be used:

$${ω}_{0} < \sqrt{( \frac{{r}_{coating} λ}{π n} ) / ( \sqrt{{( \frac{{I}_{glass index change}}{{I}_{coating damage}} )}^{2} - 1} )} = 0.77 μm$$

Therefore, the focusing optics would have to be set to obtain a <0.77 μm beam waist at the core of the fiber in order to produce index modifications in the core while not harming or damaging the carbon coating.

More generally, for a given fiber and coating, this formula would have different parameters that would be determined from a study of the fiber under various actinic exposures. For example, hermeticity can be achieved using materials other than carbon coating, such as metals. Also, the fiber may contain gettering regions or different compositions and refractive index, which inhibit the migration of hydrogen to the core. Once the parameters have been determined, then the beam focusing optics would be adjusted to satisfy this relation.

If more than one pulse is required to produce the index variation in the fiber core, then the number of pulses would have been included in the computation for the two thresholds. In this case, the relevant parameter would be the total actinic dosage D. This may be written as:

D=ItₚᵤₗₛₑNₚᵤₗₛₑₛ

where I is the pulse intensity, tₚᵤₗₛₑ is the pulse duration, and Nₚᵤₗₛₑₛ is the number of pulses. The various writing beam parameters (λ, ω₀, tₚᵤₗₛₑNₚᵤₗₛₑₛ) would then have to be adjusted to satisfy
and

D(r_{coating})<D_{coating damage}

D(r_{core})>D_{glass index change}

Or, more explicitly,

I(r_{coating})tₚᵤₗₛₑNₚᵤₗₛₑₛ(r_{coating})<D_{coating damage} (I(r_{coating}), tₚᵤₗₛₑ, Nₚᵤₗₛₑₛ(r_{coating}))

and,

I(r_{core})tₚᵤₗₛₑNₚᵤₗₛₑₛ(r_{core})>D_{glass index change} (I(r_{core}), tₚᵤₗₛₑ, Nₚᵤₗₛₑₛ(r_{core}))

Note that in these inequalities, the number of pulses is not necessarily the same at the core and coating. Such a difference may arise if the beam is larger at the coating than at the core. If the index change in the fiber core requires moving the writing beam through the core, then a given part of the coating will experience many pulses from the large writing beam while the beam is moved through the core.

In general, the parameters for the dosages will have to be determined for the fiber and the writing system, and the beam parameters will be adjusted accordingly. In order to determine the degree of degradation due to the actinic radiation, the fiber may be placed in a vessel at 130 C, with a 75 psi partial pressure of hydrogen 7 days. The attenuation of the fiber at 1550 nm may typically increase to 2 dB/km after the hydrogen exposure. The fiber exposed to actinic radiation of this invention will have an increase in attenuation, preferably of no more than 33%, i.e., to 2.7 dB/km after the same hydrogen exposure. The carbon should be at least 10 nm in thickness. However, a thicker layer may also be applied, such as a 100 nm or 1 micron thick layer. It is possible the carbon may be thick enough that it is still hermetic even after ablation by the actinic radiation exposure. Therefore, the value of I_{coating damage} may be higher than stated above.

The optical back-scatter may be increased through many different index perturbations. The scattering from the core guided mode from an index perturbation may be estimated using the coupled mode approximation. In this approximation, the amplitude of the scattered electric (E) field is proportional to an overlap integral:

E_{scattered} ∝n∝∫E_{incident}E_{scattered}δn(r, θ)dA

Where η is the overlap integral, E_{incident} is the transverse dependence of the E field amplitude of the incident guided light, E_{scattered} is the transverse dependence of the E field amplitude of the scattered E field, δn(r, θ) is the index perturbation with explicit dependence on the cylindrical coordinates transverse to the axis of the optical fiber, and the integral is over the transverse area of the fiber.

From this relation, it is clear that the desired index perturbations should overlap spatially with at least a portion of the light-guiding core or cores of the optical fiber, since E_{incident} is confined primarily to the core. In order to increase scatter into the backward propagating mode or modes, such perturbations will have minimal variation in the direction orthogonal to the fiber axis. This can be understood from the overlap integral. It can be seen that variation of δn(r, θ) in the the r and θ directions can increase the overlap integral with modes that are not guided since such modes move at an angle with respect to the fiber axis and therefore have a more transverse variation of their E fields. Since the aim of the index perturbations is to increase back-scattering into guided modes while minimizing the scattering into non-guiding, lossy modes, the desired index perturbations δn(r, θ) will have little or no dependence on r and θ.

As an example of a scattering fiber, δn(r, θ) may be considered to exist only in the core of the fiber and have little or no dependence on r and θ. The dependence along the fiber axis is then the only variation of δn. The direction along the fiber is taken to be the z-direction. The case when the variation of δn is periodic may be considered first. In this case, if such a perturbation persists over a length L and the perturbations are spaced by an amount D then the spatially averaged scattering per unit length would be:

$$R = \frac{{( \frac{πδ n η}{{λ}_{S}} L )}^{2}}{D}$$

Where η is the overlap integral discussed above. This increased scattering would have a spectral dependence that is centered at λ_{S} and with a spectral width Δλ_{BW} that is approximately:

$$Δ {λ}_{BW} ∼ \frac{{λ}_{S}^{2}}{2 nL}$$

Where n is the effective index of the guided mode, in general, if such a perturbation had uniform amplitude δn along the length L, then the spectrum would exhibit large sidebands outside of this bandwidth. As a result, to reduce the scattering outside of the main scattering bandwidth, the index perturbations would have to be apodized.

Apodization would make δn vary from a very small value to a maximum near the center of the length L and then vary again to a very low value at the other end of the length L. Such apodization could reduce the out-of-band scattering to less than 10 dB of the scattering within the bandwidth.

Another approach would exploit index perturbations that are not periodic along the fiber axis. Such a set of perturbations would increase the scattering bandwidth by changing the local period of the perturbations δn. This simplest example would be a set of perturbations whose period increases linearly with a chirp rate C_{S}. In this case, the bandwidth Δλ_{BW} for a set of perturbations with a length L would be:

Δλ_{BW}=C_{S}L

An estimate of the average reflection per unit length would be:

$$R = \frac{{( \frac{π δ n η {L}_{eff}}{{λ}_{S}} )}^{2}}{D} ∼ \frac{{( π δ n η )}^{2}}{2 n {C}_{S} D}$$

Where the effective interaction length for incident light is estimated within such a chirped set of perturbations:

$${L}_{eff}^{2} = \frac{{λ}_{S}^{2}}{2 n {C}_{S}}$$

The formulas may be used to estimate the required magnitude of the index perturbation for a given set of scattering parameters for the ESF. The scattering parameters include the scattering per unit length R, the center wavelength λ_{S} and bandwidth over which this scatter occurs Δλ_{BW}, and the spacing between the individual perturbations, D. In one example, the following values may be considered:

$$R = - 90 ( \frac{d B}{mm} ) = {10}^{- 9} ( \frac{1}{mm} )$$

$${λ}_{S} = 1550 nm$$

$$Δ {λ}_{BW} = 10 nm$$

$$D = 1 cm$$

The waveguide parameters may also be used, wherein η˜1 and n=1.45 is the effective index of the guided modes near 1550 nm. The perturbations may be approximately:

$$\frac{{λ}_{S}}{2 n} \sim 534 nm$$

Such perturbations would give “first-order scattering.” If the perturbations are further apart, it will be possible to use “higher-order scattering.” Such higher-order scattering results from higher-order spatial Fourier components of a periodic pattern of index perturbations. For N^{th} order scattering, it may be calculated by the following:

$$\frac{{λ}_{S} N}{2 n} = N \times 534 nm$$

It is noted that if a higher-order Fourier component is giving rise to the scattering, then the N^{th} order Fourier component of on may be taken into consideration. More specifically:

$$δ n ( z ) = \sum δ {n}_{m} cos ( \frac{2 π m z}{{Λ}_{p}} + {ϕ}_{m} )$$

Where Λp is the spacing of the perturbations. If the perturbation uses the N^{th} order Fourier coefficient, the perturbation giving rise to scattering at λ_{S} would be δn_{N} where:

$${λ}_{S} = \frac{2 n {Λ}_{p}}{N}$$

It is noted that in many cases, Max{δn(z)}>δnₘ. In the case of the uniform grating, the required grating length Lᵤ may be estimated as:

$${L}_{u} ∼ \frac{{λ}_{S}^{2}}{2 n Δ {λ}_{B W}} = 80 µm$$

And the required index perturbation for the uniform grating, δnᵤ would be:

$$δ {n}_{u} ∼ \frac{{λ}_{S} \sqrt{R D}}{π η {L}_{u}} = 6 \times {10}^{- 7}$$

For the chirped set of perturbations, the chirp rate may be

$${C}_{S} = \frac{10 nm}{cm} = {10}^{- 6} .$$

Then the length of the chirped pattern L_{C} may be estimated by the following:

$${L}_{C} = \frac{{Δλ}_{BW}}{{C}_{S}} = 1 cm$$

And the required index modulation would be δn_{C}

$$δ {n}_{C} \sim \frac{\sqrt{2 {nC}_{S} RD}}{πη} = 5 \times {10}^{- 8}$$

In this case the effective length of interaction would be:

$${L}_{eff} = \frac{{λ}_{S}}{\sqrt{2 {nC}_{S}}} = 900 µm$$

These parameters may also be computed in the case that D=1 m. In this case, the values of Lᵤ and L_{C} may be the same. However, the index perturbation amplitudes values are one order of magnitude larger: δnᵤ=6×10⁻⁶ and δn_{C}=5×10⁻⁷.

While uniform and linearly chirped perturbations are two examples of perturbations, many other patterns of perturbations are also possible. For instance, it is possible to have a nonlinearly chirped period. It is also possible to have each subsequent set of perturbations have a different period. Finally, it is possible to have single or multiple randomly spaced perturbations. It is also possible for the value of D to change between exposures.

A desirable ESF will have more scattering than Rayleigh scattering and will have very little additional attenuation introduced into the fiber waveguide. Therefore the index perturbations may be introduced into the waveguide in such a manner that the attenuation of the guided modes of the fiber are unchanged or very low compared to the fiber without the index perturbations. In silica-core fiber, it is well known that optical attenuation is sensitive to draw tension: higher tension (for example, due to high draw speed or low temperature) creates so-called draw-induced defects in the glass network that absorb light. The impact of higher draw tension can be mitigated by reducing the viscosity of the core, such as by doping with chlorine, fluorine, alkalis, and other elements. Similarly, because the index change due to actinic exposure is likely the result of damage to the silica glass network, optical attenuation induced during grating writing is also sensitive to draw conditions and the chemical nature of the glass. Maintaining low optical attenuation in an ESF therefore, requires careful attention to writing conditions, draw conditions and glass composition. Further, the draw conditions, such as temperature and speed, should also be suitable for producing an appropriately hermetic coating.

It is important to note that glass defects created during draw and actinic exposure are metastable, meaning they can anneal over time, with the rate of annealing dependent on the conditions of exposure, the chemistry of the glass, and the annealing conditions (typically time and temperature). Gratings in ESF are typically written at higher strength to allow for some degree of recovery during annealing prior to or during actual use. Determination of grating strength and optical attenuation usually account for changes during annealing.

According to one embodiment, the increased attenuation for the two examples above may be considered. In general, the fiber will have an attenuation coefficient α before exposure and a transmission of e^{-αz} over length z of fiber. After exposure, the attenuation coefficient will be αₑ=α+δα(δn), where δα is the change in attenuation coefficient of the portion of the fiber that was exposed to give the perturbation δn. In addition, it is possible that there will be discrete attenuation points that do not depend on the length of the perturbation L, but only on, for instance, the index step discontinuity at the start and end of the index perturbation. The transmission through such a discrete loss point is e^{-δα}^{_{d}}^{(δn)}.

If D>L, then the attenuation coefficient over the length D would then be:

$${α}_{ESF} = \frac{α ( D - L )}{D} + \frac{( α + δα ( δ n ) ) L}{D} + \frac{{δα}_{d} ( δ n )}{D} = α + \frac{δα ( δ n ) L}{D} + \frac{{δα}_{d} ( δ n )}{D}$$

The transmission over any length z would then be

$${e}^{- ( α + \frac{δα ( δ n ) L}{D} + \frac{{δα}_{d} ( δ n )}{D} ) z}$$

The scattering figure of merit would be, in the case of the uniform period perturbation:

$$F O M = \frac{R}{{α ( \frac{N A}{2 n} )}^{2}} \sim \frac{{( \frac{πδ n η}{{λ}_{S}} L )}^{2}}{( D α + δα ( δ n ) L + {δα}_{d} ( δ n ) ) {( \frac{N A}{2 n} )}^{2}}$$

Where NA is the fiber numerical aperture. And in the case of the chirped perturbation,

$$F O M \sim \frac{\frac{{( πδ n η )}^{2}}{2 n {C}_{S}}}{( D α + δ α ( δ n ) L + {δα}_{d} ( δ n ) ) {( \frac{N A}{2 n} )}^{2}}$$

The perturbations on must be introduced into the waveguide so that the scattering FOM is maximized.

According to one exemplary embodiment, notable elements for a test femto scattering fiber may include:
1) Fiber: something with a Ge core and carbon/polyimide;
2) Spacing: 10 cm;
3) Grating length 0.5 mm;
4) Reflection bandwidth 1540 nm+−6 nm;
5) Chirp approximately linear, but not too critical;
6) Reflection strength for one grating R=−70 dB; and
7) Length 200 m.

For instance, one could start with some test gratings with various strengths (e.g., from −75 dB to −50 dB in a short length). Such a process may be used to test on shorter lengths of fiber. Other testing procedures may examine hydrogen sensitivity, attenuation, mechanical strength, thermal stability at a predetermined temperature (e.g., 150 C), etc.

The present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An optical fiber having a modified refractive index caused by applying actinic-pulse radiation creates a refractive index perturbation, the optical fiber comprising:
a core;
a cladding;
a hermetic coating layer; and
a coating, wherein the refractive index perturbation is inscribed along the length of the core of the optical fiber, and wherein reflectivity of the refractive index perturbation is within a range from −100 dB/mm to −70 dB/mm.

2. The optical fiber of claim 1, wherein the refractive index perturbation is spatially continuous.

3. The optical fiber of claim 1, wherein the refractive index perturbation is at discrete locations spaced apart within a range of 100 microns to >10 m.

4. The optical fiber of claim 1, wherein the refractive index perturbation is centered between approximately 1500 nm and approximately 1700 nm.

5. The optical fiber of claim 1, wherein the refractive index perturbation is present at wavelengths in which Rayleigh scattering occurs.

6. The optical fiber of claim 1, wherein the refractive index perturbation has a spatial extent within a range from 1 micron to >10 cm.

7. The optical fiber of claim 1, wherein a center of the refractive index perturbation has a spectral reflection bandwidth of less than 10 nm.

8. The optical fiber of claim 1, wherein a center of the refractive index perturbation has a spectral reflection bandwidth of less than 30 nm.

9. The optical fiber of claim 1, wherein a center of the refractive index perturbation has a spectral reflection bandwidth of less than 100 nm.

10. The optical fiber of claim 1, wherein the core is a germanium-free core.

11. The optical fiber of claim 1, wherein the hermetic coating layer is carbon.

12. The optical fiber of claim 1, further comprising a length that exceeds 1 m.
